(19) United States
(12) Patent Application Publication
(10) Pub. No.: US 2025/0281909 A1
(43) Pub. Date: Sep. 11, 2025

(54) CATALYSTS FOR OXIDIZING COKE IN A LOW OXYGEN ENVIRONMENT

(71) Applicant: General Electric Company, Schenectady, NY (US)

(72) Inventors: Karthick Gourishankar, Bengaluru (IN); Sanat Chandra Maiti, Bengaluru (IN); Sanjay Kumar Sondhi, Bengaluru (IN); Atanu Saha, Bengaluru (IN)

(21) Appl. No.: 18/595,987

(22) Filed: Mar. 5, 2024

(51) Int. Cl. B01J 23/10; B01J 23/00; B01J 23/02; F01D 25/00; F23C 13/08

(52) U.S. Cl. CPC B01J 23/10; B01J 23/002; B01J 23/02; F01D 25/00; F23C 13/08; B01J 2523/22; B01J 2523/23; B01J 2523/31; B01J 2523/3712; B01J 2523/375; B01J 2523/41; F05D 2300/611

(57) ABSTRACT

A catalyst for oxidizing coke in a low oxygen environment such as in a gas turbine engine of an aircraft. The catalyst includes a compound of formula NₓM₁₋ₓO_{2-y}. In the formula, x ranges from 0 to 0.9, y ranges from 0.02 to 0.2, N includes at least one of an alkaline-earth cation, an aluminum cation, a transition metal cation, or a rare-earth cation, M is silicon or a rare-earth element, and N has a different atomic radius than M, N has a different oxidation state than M, or N has a different atomic radius and a different oxidation state than M.

### TECHNICAL FIELD

The present disclosure relates to coating materials, coated substrates, and methods using the same to reduce coke deposits, for example, on gas turbine engines for aircraft.

### BACKGROUND

Gas turbine engines include surfaces that contact hydrocarbon fluids, such as fuels and lubricating oils. Carbonaceous deposits (also known as coke) may form on these surfaces when exposed to the hydrocarbon fluids at elevated temperatures, resulting in coke becoming attached to surfaces contacted by a fuel or oil and building up as deposits on those surfaces contacted by a fuel or oil.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIGS. 1A and 1B are cross-sectional views of a catalyst coating applied on a substrate.

FIG. 2 is a schematic view of an aircraft having a gas turbine engine according to an embodiment of the present disclosure.

FIG. 3 is a cross-sectional view taken along line 2-2 in FIG. 2, of the gas turbine engine of the aircraft shown in FIG. 2.

FIG. 4 is a cross-sectional view of a combustor of the gas turbine engine shown in FIG. 3 according to an embodiment of the present disclosure. FIG. 4 is a detail view showing detail 4 in FIG. 3.

FIG. 5 is a cross-sectional view of a mixer assembly of the combustor in FIG. 4. FIG. 5 is a detail view showing detail 5 in FIG. 4.

FIG. 6 is a cross-sectional view of a combustor of the gas turbine engine shown in FIG. 3 according to another embodiment of the present disclosure.

FIG. 7 is a cross-sectional view of a mixer assembly of the combustor in FIG. 6. FIG. 7 is a detail view showing detail 7 in FIG. 6.

FIG. 8 is a cross-sectional view of a catalyst coating applied on surfaces of a venturi and an aft heat shield.

FIG. 9 depicts normalized carbon mass loss in air or a low oxygen environment.

FIG. 10 depicts normalized carbon mass loss for some catalyst embodiments of the disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the present disclosure.

The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows. The term “fluid” may be a gas or a liquid. The term “fluid communication” means that a fluid is capable of making the connection between the areas specified.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The term “rare-earth” refers to elements of groups 3 and 4 of the first, second, and third transition series of the periodic table, e.g., scandium, yttrium, zirconium, and hafnium, and elements of the lanthanide series of the periodic table, e.g., lanthanum, cerium, praseodymium, neodymium, promethium, samarium, europium, gadolinium, terbium, dysprosium, holmium, erbium, thulium, ytterbium, lutetium, and combinations thereof.

The term “alkaline-earth” refers to the elements beryllium (Be), magnesium (Mg), calcium (Ca), strontium (Sr), barium (Ba), radium (Ra), and combinations thereof.

The term “transition metal” refers to the elements of Groups 3 (IIIb) through 12 (IIb) of the periodic table and combinations thereof.

As used herein, an alloy is “based” on a particular element when that element is present in the alloy at the greatest weight percent, by total weight of the alloy, of all elements contained in the alloy. For example, an iron-based alloy has a higher weight percentage of iron than any other single element present in the alloy.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially” is not to be limited to the precise value specified. In at least some instances, the approximating language may correspond to the precision of an instrument for measuring the value, or the precision of the methods or machines for constructing or manufacturing the components and/or systems. For example, the approximating language may refer to being within a one, two, four, ten, fifteen, or twenty percent margin in either individual values, range(s) of values, and/or endpoints defining range(s) of values.

Here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other.

As noted above, coke deposition may occur on surfaces of a gas turbine engine that are exposed to hydrocarbon fluids, such as fuels and lubricating oils, at elevated temperatures. The fuel nozzle and swirler (collectively, a mixer assembly) used in a combustor for a gas turbine engine includes such surfaces. A fuel nozzle aft heat shield (FN-AHS) protects the fuel nozzle from hot combustion gases during engine operation. Surfaces of the FN-AHS and other surfaces of the mixer assembly are exposed to hydrocarbon fluids, such as fuel, and operation of the gas turbine engine, particularly, continuous operation at cruise for aircraft gas turbine engines, can result in significant build-up of coke and/or partially burned fuel deposits on exposed surfaces of the FN-AHS and the mixer assembly.

Coke can build up in considerable thickness, and large pieces of coke can shed off these surfaces, becoming internal domestic objects that can cause significant damage to components downstream of the fuel nozzle (hot gas path components). Some of these components have thermal barrier coatings (TBCs). The resulting internal domestic object impact damage (DoD) may result in spallation of the thermal barrier coating and may reduce the durability of components such as combustors, nozzles, shrouds, and airfoils. The coke deposits can be reduced or eliminated using a catalyst capable of oxidizing coke because coke oxidation may convert solid coke deposits to gaseous reaction products. For example, coke oxidation may include the reaction of carbon with diatomic oxygen to form reaction products such as carbon monoxide and carbon dioxide. Without a catalyst, coke oxidation may be slower or less effective in a low oxygen environment because of the low concentration of the diatomic oxygen, which may be a reactant in the coke oxidation reaction. Such low oxidation environments may form in the presence of a combustion reaction that consumes diatomic oxygen, such as, for example, downstream of a combustion chamber. There may be, however, other causes for a low oxygen environment including, for example, a high-altitude environment. A coke oxidation catalyst may help reduce coke deposits by catalyzing coke oxidation in a low oxygen environment. For example, at least a portion of the catalyst may be at least partially reactive for catalyzing coke oxidation in a low oxygen environment.

In some embodiments, the catalyst for oxidizing coke in a low oxygen environment includes a compound of formula NₓM₁₋ₓO_{2-y}. In such embodiments, x ranges from, for example, 0 to 0.9, y ranges from, for example, 0.02 to 0.9 (e.g., from 0.02 to 0.2), N includes at least one of an alkaline-earth cation, an aluminum cation, a transition metal cation, or a rare-earth cation, M is silicon or a rare-earth element, and N has a different atomic radius than M, N has a different oxidation state than M, or N has a different atomic radius and a different oxidation state than M. Without intending to be bound by theory, particular combinations and ratios of elements in the catalyst may impart the catalyst with effective amounts of suitably reactive oxygen defect sites that aid in the oxidation of coke in low oxygen environments. For example, the inventors surprisingly found that, in some embodiments, the catalyst is effective for oxidizing coke at an oxygen partial pressure of 0.02 atmospheres with an oxidation onset temperature ranging from eight hundred degrees Fahrenheit (four hundred twenty six degrees Celsius) to one thousand six hundred degrees Fahrenheit (eight hundred seventy one degrees Celsius).

In some embodiments, the catalyst includes a compound of formula NₓM₁₋ₓO_{2-y} and x ranges from 0.2 to 0.9, M is silicon, y ranges from, for example, 0.02 to 0.9 (e.g., from 0.02 to 0.2), N is at least two of alkaline-earth cations, aluminum cation, transition metal cations, or rare-earth cations. In some embodiments, the catalyst is free from platinum group metals, and, in some embodiments, the catalyst is free from noble metals.

In such embodiments, the amounts and types of oxygen defect sites may be controlled, for example, by adjusting the amounts and types of the cations. For example, the combination of two or more cations having different atomic radii, different oxidation states, or different atomic radii and different oxidation states may introduce defects sites in the catalyst by disrupting the local atomic structure of the catalyst.

While the catalyst may include various amounts of each component, in some embodiments, at least fifty weight percent (e.g., at least ninety-five weight percent) of the catalyst includes the silicon dioxide and the at least two cations. Moreover, in some embodiments, the catalyst has one or more compositional properties chosen from zero mole percent to fifty mole percent alkaline-earth cations, zero mole percent to twenty mole percent aluminum cations, zero mole percent to twenty mole percent transition metal cations, and zero mole percent to eighty mole percent rare-earth cations. Further, in some embodiments, the catalyst has one or more compositional properties chosen from thirty mole percent to forty mole percent alkaline-earth cations, five mole percent to ten mole percent aluminum cations, five mole percent to ten mole percent transition metal cations, and zero mole percent to eighty mole percent rare-earth cations (e.g., thirty mole percent to sixty mole percent rare-earth cations).

As noted above, ratios of the various components may also impact the amount and the type of oxygen defect sites. For example, in some embodiments, the catalyst has from a ratio of silicon to alkaline-earth cations ranging from one to ten, a ratio of silicon to aluminum cations ranging from one to twenty, a ratio of silicon to transition metal cations ranging from one to twenty, or a ratio of silicon to rare-earth cations ranging from 0.5 to four. Further, in some embodiments, the catalyst has from a ratio of silicon to alkaline-earth cations ranging from five to ten, a ratio of silicon to aluminum cations ranging from ten to fifteen, a ratio of silicon to transition metal cations ranging from ten to fifteen, or a ratio of silicon to rare-earth cations ranging from one to two.

In some other embodiments, the catalyst includes a compound of formula NₓM₁₋ₓO_{2-y} and x is zero, y ranges from 0.02 to 0.1, and M is a rare-earth element. For example, in some embodiments, the M is cerium. The y value may be adjusted, for example, by varying the processing conditions (e.g., temperature, pressure, particle size, etc.). Having a different y value may result in different amounts and types of oxygen defect sites in the catalyst.

In yet other embodiments, the catalyst includes a compound of formula NₓM₁₋ₓO_{2-y} and x ranges from 0.02 to 0.5, y ranges from 0.02 to 0.1, M is a rare-earth element, and N comprises a rare-earth cation. For example, in some embodiments, the M is cerium. In some embodiments, the N comprises gadolinium, for example, N may comprise gadolinium and lanthanum. The amounts and types of rare-earth cations denoted by N may result in different amounts and types of oxygen defect sites in the catalyst. For example, because gadolinium and lanthanum may have different atomic radii, different oxidation states, or different atomic radii and different oxidation states from each other and from M (e.g., cerium), different amounts and ratios of these components may result in different amounts and types of oxygen defect sites.

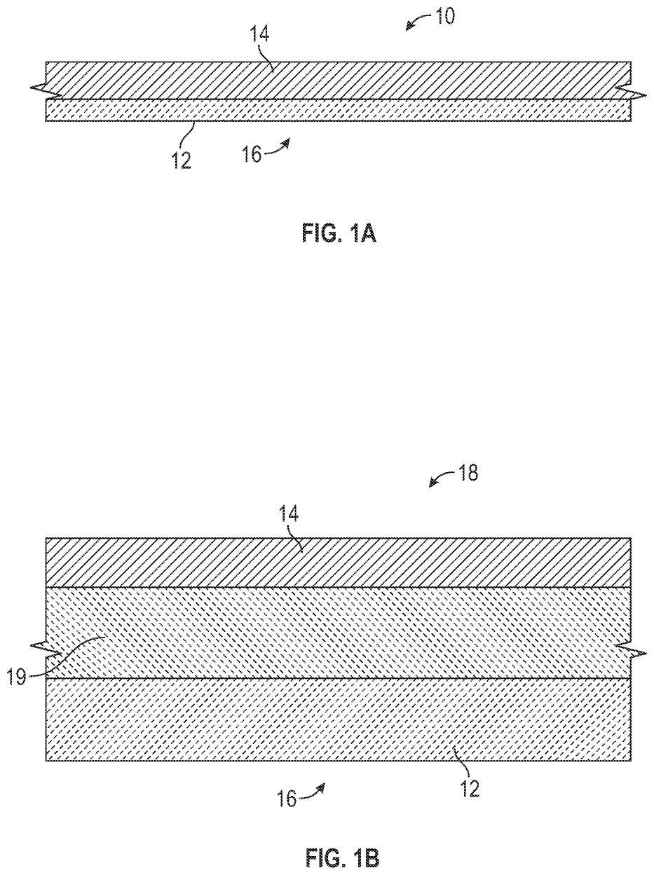

FIG. 1A depicts a catalyst 12 coated on a substrate 14. The disclosed catalyst may be coated on any substrate 14. The substrate 14 may be any metal substrate or ceramic substrate. The substrate 14 may be a portion of a component 10 that is positioned or otherwise arranged to come into contact with, for example, a hydrocarbon fluid, such as fuel, oil, and the like, as discussed further below, and the catalyst 12 may be coated on surface of the substrate facing the hydrocarbon fluid, such as a surface facing or otherwise defining a passage 16 for the hydrocarbon fluid to flow therethrough.

FIG. 1B also depicts the catalyst 12 coated on the substrate 14. A component 18 depicted in FIG. 1B is similar to the component 10 depicted in FIG. 1A. In some applications, the substrate 14 may be a metal and may have a ceramic coating 19 (such as a thermal barrier coating (TBC)) on the metal substrate. As discussed further below, the catalyst 12 may be applied as a coating on top of the TBC, as depicted in FIG. 1B, or be integrated within the TBC. Example materials for TBCs include yttria-stabilized zirconia (YSZ such as 8 YSZ, 20 YSZ, 55 YSZ), La—Gd-Zirconate, La—Yb-Zirconate, La—Gd—Yb-Zirconate, rare-earth-Ta-Zirconate, rare-earth-Nb-Zirconate, and (ZrO₂)_{(1-z)}(Y₂O₃)_{z} wherein z ranges from 0.04 to 0.5. The metal substrates may include, for example, iron-based alloys, nickel-based alloys, cobalt-based alloys, alloys containing cobalt and chromium, alloys containing platinum and aluminum, alloys containing nickel and aluminum, or alloys containing nickel, chromium, aluminum, and yttrium.

The disclosed catalyst may be coated on a substrate using any suitable coating technique. For example, the catalyst can be integrated into TBC materials as a thin coating via sol-gel precursor or sol impregnation, to allow the coating to adhere conformally without altering the TBC roughness or adversely affecting useful features such as dense vertical cracks (DVC), which assist strain compliance. In some embodiments, the catalyst particles can be integrated into TBC materials by mixing the source TBC materials in powder form in different proportions (for example, from ten weight percent to ninety-five weight percent) so that they can be applied as part of the TBC application process using APS or EBPVD methods. In some embodiments, the catalyst particles can be integrated into TBC materials as graded layers of catalyst applied on the TBC surface. For example, a first layer is the TBC material, a second layer is a combination of ninety percent TBC material and ten percent catalyst, a third layer is a combination of fifty percent TBC material and fifty percent catalyst, and a fourth layer is one hundred percent catalyst. For example, up to five layers may exist, with each layer having thicknesses ranging from one hundred nanometers to ten microns.

As noted above, the coke deposits can be reduced or eliminated using a catalyst capable of oxidizing carbon (e.g., in coke or coke precursors) because carbon oxidation may, for example, convert carbonaceous deposits (e.g., coke) to gaseous reaction products. For example, coke oxidation may include the reaction of carbon with diatomic oxygen to form reaction products such as carbon monoxide and carbon dioxide. The catalyst discussed herein may be used to oxidize coke, coke precursors, or both in a low oxygen environment, such as by catalyzing an oxidation reaction. For example, a method of oxidizing coke in a low oxygen environment includes contacting the catalyst with coke, and the low oxygen environment having a partial pressure of oxygen ranging from, for example, 0.5 volume percent to twenty-one volume percent when the contacting step occurs at a temperature ranging from, for example, one thousand degrees Fahrenheit (five hundred thirty seven degrees Celsius) to three thousand degrees Fahrenheit (one thousand six hundred forty eight degrees Celsius).

Coke oxidation reactions may have an onset temperature, which can be determined by, for example, an inflection point in a graph of normalized carbon loss as a function of temperature. Without the catalyst, the onset temperature of the oxidation reactions discussed herein may be from one thousand two hundred degrees Fahrenheit (six hundred forty eight degrees Celsius) to one thousand six hundred degrees Fahrenheit (eight hundred seventy one degrees Celsius). The catalyst may reduce an onset temperature for the coke oxidation reaction by an amount ranging from, for example, one hundred and twenty degrees Fahrenheit (forty eight degrees Celsius) to five hundred degrees Fahrenheit (two hundred sixty degrees Celsius), or, for example, six hundred and sixty degrees Fahrenheit (three hundred forty eight degrees Celsius) to eight hundred and forty degrees Fahrenheit (four hundred forty nine degrees Celsius). An onset temperature for coke oxidation can be determined by measuring, for example, the rate of normalized carbon mass loss as a function of temperature when the catalyst contacts the carbon in a low oxygen environment.

Coke oxidation using the catalyst can be operated in a temperature ranging from, for example, three hundred degrees Fahrenheit (one hundred forty eight degrees Celsius) to two thousand five hundred and fifty degrees Fahrenheit (one thousand four hundred degrees Celsius), such as, three hundred degrees Fahrenheit (one hundred forty eight degrees Celsius) to one thousand one hundred degrees Fahrenheit (five hundred ninety three degrees Celsius), such as, five hundred seventy degrees Fahrenheit (two hundred sixty degrees Celsius) to one thousand one hundred degrees Fahrenheit (five hundred ninety three degrees Celsius), nine hundred thirty degrees Fahrenheit (five hundred degrees Celsius) to three thousand one hundred degrees Fahrenheit (one thousand seven hundred five degrees Celsius) (e.g., one thousand degrees Fahrenheit (five hundred thirty seven degrees Celsius) to three thousand degrees Fahrenheit (one thousand six hundred forty eight degrees Celsius)), or one thousand one hundred degrees Fahrenheit (five hundred ninety three degrees Celsius) to two thousand six hundred degrees Fahrenheit (one thousand four hundred twenty seven degrees Celsius).

Coke oxidation using the catalyst can be operated in an oxygen-containing environment ranging from, for example, 0.5 volume percent to twenty-one volume percent of gaseous oxygen, 0.5 volume percent to ten volume percent of gaseous oxygen, five volume percent to twenty-one volume percent of gaseous oxygen, or five volume percent to ten volume percent of gaseous oxygen.

As noted above, a catalyst coated substrate (e.g., substrate 14 in FIGS. 1A and 1B) may be any component that may be subject to coke formation. For example, the catalyst coated substrate may be a gas turbine engine component such as any of the gas turbine engine components disclosed herein. The gas turbine may be a gas turbine for an aircraft or may be a terrestrial turbine such as for a power plant, or a maritime gas turbine engine for a ship. In some embodiments, the catalyst coated substrate is an aircraft component such as any of the aircraft components disclosed herein including, for example, a fuel circuit component, a lube oil circuit component, a fuel nozzle (e.g., a venturi surface on the fuel nozzle), a mixer assembly component, and an aft heat shield. In some embodiments, the catalyst coated substrate is any fuel circuit or lube oil circuit component where hydrocarbon based fluids can form coke deposits (e.g., carbon-based deposits) on component walls because of exposure to coking conditions (e.g., conditions having suitable temperatures and oxygen availability to form coke). In some embodiments, the catalyst coated substrate is an aft heat shield. An aft heat shield can be exposed to a low-oxygen environment during engine operation. Some such components are described in more detail below.

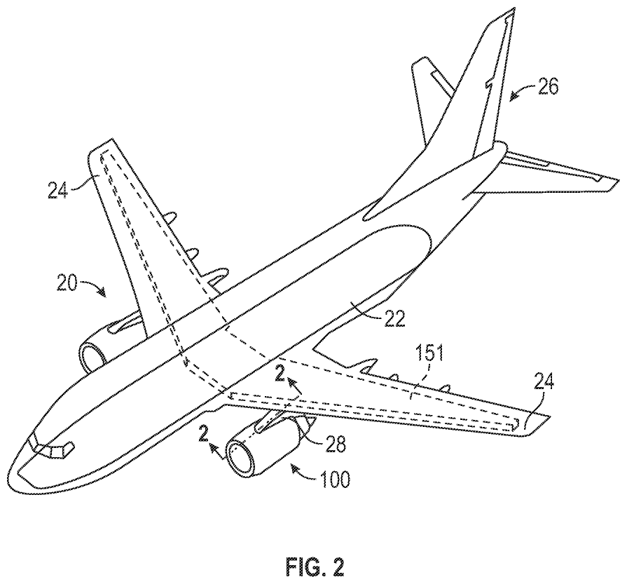

FIG. 2 shows an aircraft 20 that may implement various embodiments. The aircraft 20 includes a fuselage 22, wings 24 attached to the fuselage 22, and an empennage 26. The aircraft 20 also includes a propulsion system that produces a propulsive thrust required to propel the aircraft 20 in flight, during taxiing operations, and the like. The propulsion system for the aircraft 20 shown in FIG. 2 includes a pair of engines 100. In this embodiment, each engine 100 is attached to one of the wings 24 by a pylon 28 in an under-wing configuration. Although the engines 100 are shown attached to the wing 24 in an under-wing configuration in FIG. 2, in other embodiments, the engine 100 may have alternative configurations and be coupled to other portions of the aircraft 20. For example, the engine 100 may additionally or alternatively include one or more aspects coupled to other parts of the aircraft 20, such as, for example, the empennage 26, and the fuselage 22.

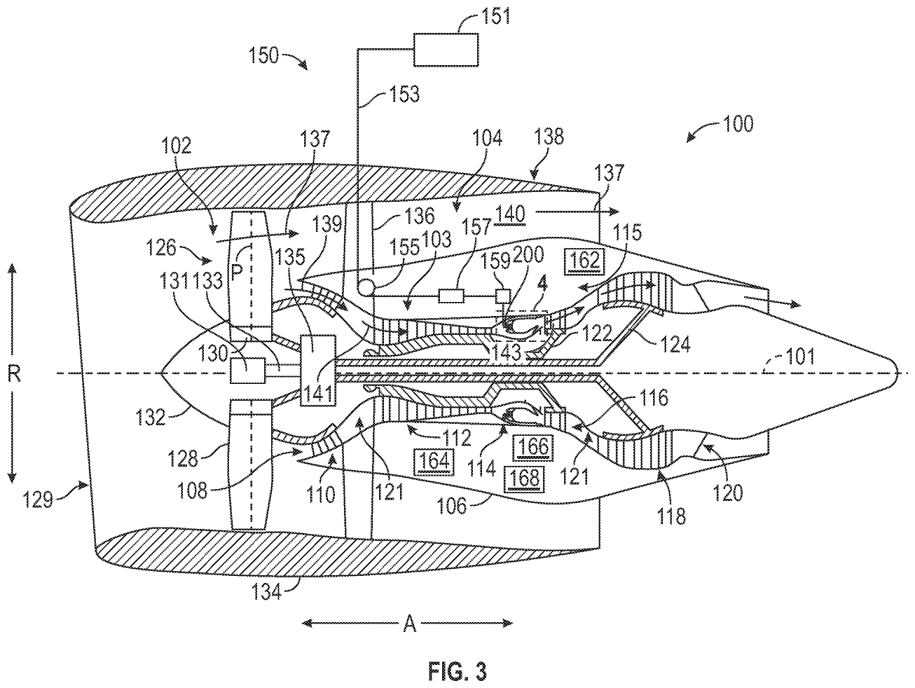

As will be described further below, with reference to FIG. 3, the engines 100 shown in FIG. 2 are gas turbine engines that are each capable of selectively generating a propulsive thrust for the aircraft 20. The amount of propulsive thrust may be controlled at least in part based on a volume of fuel provided to the engine 100 (e.g., a gas turbine engine) via a fuel system 150 (see FIG. 3). An aviation turbine fuel in the embodiments discussed herein is a combustible hydrocarbon liquid fuel, such as a kerosene-type fuel, having a desired carbon number, a synthetic aviation fuel, a biofuel, a biodiesel, an ethanol, a bioalcohol, and the like. The fuel is stored in a fuel tank 151 of the fuel system 150. As shown in FIG. 2, at least a portion of the fuel tank 151 is located in each wing 24 and a portion of the fuel tank 151 is located in the fuselage 22 between the wings 24. The fuel tank 151, however, may be located at other suitable locations in the fuselage 22 or the wing 24. The fuel tank 151 may also be located entirely within the fuselage 22 or the wing 24. The fuel tank 151 may also be separate tanks instead of a single, unitary body, such as, for example, two tanks each located within a corresponding wing 24.

Although the aircraft 20 shown in FIG. 2 is an airplane, the embodiments described herein may also be applicable to other aircraft 20, including, for example, helicopters and unmanned aerial vehicles (UAV). The aircraft discussed herein are fixed-wing aircraft or rotor aircraft that generate lift by aerodynamic forces acting on, for example, a fixed wing (e.g., the wing 24) or a rotary wing (e.g., a rotor of a helicopter), and are heavier-than-air aircraft, as opposed to lighter-than-air aircraft (such as a dirigible). Further, although not depicted herein, in other embodiments, the gas turbine engine may be any other suitable type of gas turbine engine, such as an industrial gas turbine engine incorporated into a power generation system, a nautical gas turbine engine, etc.

FIG. 3 is a schematic, cross-sectional view of one of the engines 100 used in the propulsion system for the aircraft 20 shown in FIG. 2. The cross-sectional view of FIG. 3 is taken along line 2-2 in FIG. 2. For the embodiment depicted in FIG. 3, the engine 100 is a high bypass engine. The engine 100 has an axial direction A (extending parallel to a longitudinal centerline axis 101, shown for reference in FIG. 3), a radial direction R, and a circumferential direction. The circumferential direction (not depicted in FIG. 3) extends in a direction rotating about the axial direction A. The engine 100 includes a fan section 102 and a turbo-engine 104 disposed downstream from the fan section 102.

The turbo-engine 104 depicted in FIG. 3 includes, in serial flow relationship, a compressor section 103, a combustion section 114, and a turbine section 115. The turbo-engine 104 is substantially enclosed within an outer casing 106 that is substantially tubular and defines a core inlet 108. The core inlet 108 is annular in the depicted embodiment. As schematically shown in FIG. 3, the compressor section 103 includes a booster or a low pressure (LP) compressor 110 followed downstream by a high pressure (HP) compressor 112. The combustion section 114 is downstream of the compressor section 103. The turbine section 115 is downstream of the combustion section 114 and includes a high pressure (HP) turbine 116 followed downstream by a low pressure (LP) turbine 118. The turbo-engine 104 further includes a jet exhaust nozzle section 120 that is downstream of the turbine section 115, a high-pressure (HP) shaft 122 or a spool, and a low-pressure (LP) shaft 124. The HP shaft 122 drivingly connects the HP turbine 116 to the HP compressor 112. The HP turbine 116 and the HP compressor 112 rotate in unison through the HP shaft 122. The LP shaft 124 drivingly connects the LP turbine 118 to the LP compressor 110. The LP turbine 118 and the LP compressor 110 rotate in unison through the LP shaft 124. The compressor section 103, the combustion section 114, the turbine section 115, and the jet exhaust nozzle section 120 together define a core air flow path 121 through which core air 139 flows.

The fan section 102 shown in FIG. 3 includes a fan 126 (e.g., a variable pitch fan) having a plurality of fan blades 128 coupled to a disk 130 in a spaced apart manner. As depicted in FIG. 3, the fan blades 128 extend outwardly from the disk 130 generally along the radial direction R. In the case of a variable pitch fan, the plurality of fan blades 128 are rotatable relative to the disk 130 about a pitch axis P by virtue of the fan blades 128 being operatively coupled to an actuation member 131 configured to collectively vary the pitch of the fan blades 128 in unison. The fan blades 128, the disk 130, and the actuation member 131 are together rotatable about the longitudinal centerline axis 101 via a fan shaft 133 that is powered by the LP shaft 124 across a power gearbox, also referred to as a gearbox assembly 135. In this way, the fan 126 is drivingly coupled to, and powered by, the turbo-engine 104, and the engine 100 is an indirect drive engine. The gearbox assembly 135 is shown schematically in FIG. 3. The gearbox assembly 135 may be a reduction gearbox assembly for adjusting the rotational speed of the fan shaft 133 and, thus, the fan 126 relative to the LP shaft 124 when power is transferred from the LP shaft 124 to the fan shaft 133.

Referring still to the exemplary embodiment of FIG. 3, the disk 130 is covered by a fan hub 132 that is aerodynamically contoured to promote an airflow through the plurality of fan blades 128. In addition, the fan section 102 includes an annular fan casing or a nacelle 134 that circumferentially surrounds the fan 126 and at least a portion of the turbo-engine 104. The nacelle 134 is supported relative to the turbo-engine 104 by a plurality of outlet guide vanes 136 that are circumferentially spaced about the nacelle 134 and the turbo-engine 104. Moreover, a downstream section 138 of the nacelle 134 extends over an outer portion of the turbo-engine 104, and, with the outer casing 106, defines a bypass airflow passage 140 therebetween.

During operation of the engine 100, a volume of air enters the turbine engine (e.g., engine 100) through an engine inlet 129 of the nacelle 134 or the fan section 102. As the volume of air passes across the fan blades 128, a first portion of air, also referred to as bypass air 137, is routed into the bypass airflow passage 140, and a second portion of air, also referred to as core air 139, is routed into the upstream section of the core air flow path 121 through the core inlet 108 of the LP compressor 110. The ratio between the bypass air 137 and the core air 139 is commonly known as a bypass ratio. The pressure of the core air 139 is then increased in the compressor section 103 and, more specifically, the LP compressor 110, generating compressed air 141. The compressed air 141 is routed through the HP compressor 112, where the compressed air 141 is further compressed, and into the combustion section 114, where the compressed air 141 is mixed with fuel and ignited to generate combustion gases 143.

The combustion gases 143 are routed into the HP turbine 116 and expanded through the HP turbine 116 where a portion of thermal energy or kinetic energy from the combustion gases 143 is extracted via one or more stages of HP turbine stator vanes and HP turbine rotor blades that are coupled to the HP shaft 122. This causes the HP shaft 122 to rotate, thereby supporting operation of the HP compressor 112 (self-sustaining cycle). In this way, the combustion gases 143 do work on the HP turbine 116. The combustion gases 143 are then routed into the LP turbine 118 and expanded through the LP turbine 118. Here, a second portion of the thermal energy or the kinetic energy is extracted from the combustion gases 143 via one or more stages of LP turbine stator vanes and LP turbine rotor blades that are coupled to the LP shaft 124. This causes the LP shaft 124 to rotate, thereby supporting operation of the LP compressor 110 (self-sustaining cycle) and rotation of the fan 126 via the gearbox assembly 135. In this way, the combustion gases 143 do work on the LP turbine 118.

The combustion gases 143 are subsequently routed through the jet exhaust nozzle section 120 of the turbo-engine 104 to provide propulsive thrust. Simultaneously, the bypass air 137 is routed through the bypass airflow passage 140 before being exhausted from a fan nozzle exhaust section of the engine 100, also providing propulsive thrust. The HP turbine 116, the LP turbine 118, and the jet exhaust nozzle section 120 at least partially define a hot gas path for routing the combustion gases 143 through the turbo-engine 104.

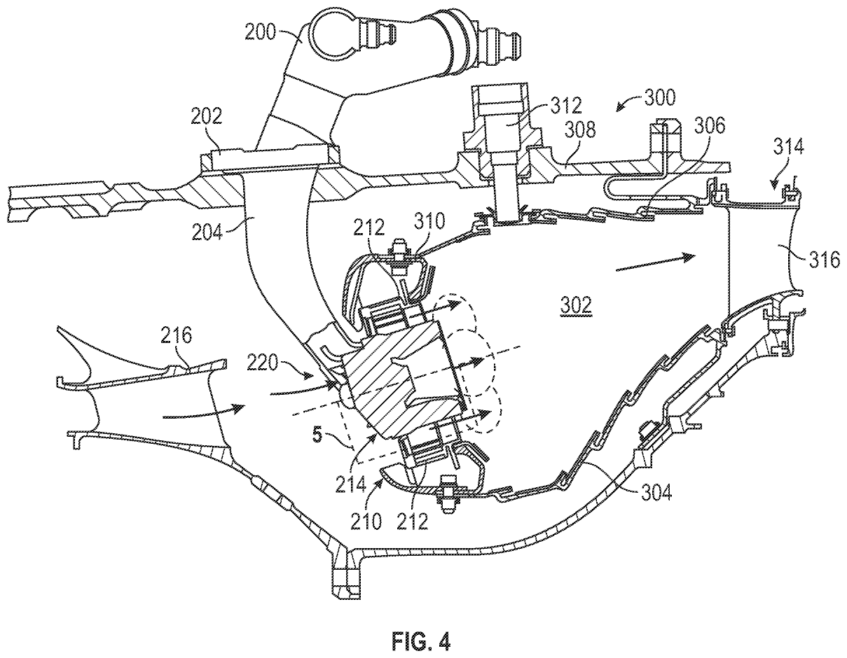

The engine 100 is operable with the fuel system 150 and receives a flow of fuel from the fuel system 150. The fuel system 150 includes a fuel delivery assembly 153 providing the fuel flow from the fuel tank 151 to the engine 100, and, more specifically, to a plurality of fuel injectors 200 that inject fuel into a combustion chamber 302 of a combustor 300 (see FIG. 4, discussed further below) of the combustion section 114.

The components of the fuel system 150, and, more specifically, the fuel tank 151, is an example of a fuel source that provides fuel to the fuel injectors 200, as discussed in more detail below. The fuel delivery assembly 153 includes tubes, pipes, conduits, and the like, to fluidly connect the various components of the fuel system 150 to the engine 100. The fuel tank 151 is configured to store the hydrocarbon fuel, and the hydrocarbon fuel is supplied from the fuel tank 151 to the fuel delivery assembly 153. The fuel delivery assembly 153 is configured to carry the hydrocarbon fuel between the fuel tank 151 and the engine 100 and, thus, provides a flow path (fluid pathway) of the hydrocarbon fuel from the fuel tank 151 to the engine 100.

The fuel system 150 includes at least one fuel pump fluidly connected to the fuel delivery assembly 153 to induce the flow of the fuel through the fuel delivery assembly 153 to the engine 100. One such pump is a main fuel pump 155. The main fuel pump 155 is a high-pressure pump that is the primary source of pressure rise in the fuel delivery assembly 153 between the fuel tank 151 and the engine 100. The main fuel pump 155 may be configured to increase a pressure in the fuel delivery assembly 153 to a pressure greater than a pressure within the combustion chamber 302 (FIG. 4) of the combustor 300.

The fuel system 150 also includes a fuel metering unit 157 in fluid communication with the fuel delivery assembly 153. Any suitable fuel metering unit 157 may be used including, for example, a metering valve. The fuel metering unit 157 is positioned downstream of the main fuel pump 155 and upstream of a fuel manifold 159 configured to distribute fuel to the fuel injectors 200. The fuel system 150 is configured to provide the fuel to the fuel metering unit 157, and the fuel metering unit 157 is configured to receive fuel from the fuel tank 151. The fuel metering unit 157 is further configured to provide a flow of fuel to the engine 100 in a desired manner. More specifically, the fuel metering unit 157 is configured to meter the fuel and to provide a desired volume of fuel, at, for example, a desired flow rate, to the fuel manifold 159 of the engine 100. The fuel manifold 159 is fluidly connected to the fuel injectors 200 and distributes (provides) the fuel received to the plurality of fuel injectors 200, where the fuel is injected into the combustion chamber 302 (FIG. 4) and combusted. Adjusting the fuel metering unit 157 changes the volume of fuel provided to the combustion chamber 302 and, thus, changes the amount of propulsive thrust produced by the engine 100 to propel the aircraft 20.

The engine 100 also includes various accessory systems to aid in the operation of the engine 100 and/or an aircraft that includes the engine 100. For example, the engine 100 may include a main lubrication system 162, a compressor cooling air (CCA) system 164, an active thermal clearance control (ATCC) system 166, and a generator lubrication system 168, each of which is depicted schematically in FIG. 3. The main lubrication system 162 is configured to provide a lubricant to, for example, various bearings and gear meshes in the compressor section 103, the turbine section 115, the HP spool 122, and the LP shaft 124. The lubricant provided by the main lubrication system 162 may increase the useful life of such components and may remove a certain amount of heat from such components through the use of one or more heat exchangers. The compressor cooling air (CCA) system 164 provides air from one or both of the HP compressor 112 or the LP compressor 110 to one or both of the HP turbine 116 or the LP turbine 118. The active thermal clearance control (ATCC) system 166 acts to minimize a clearance between tips of turbine blades and casing walls as casing temperatures vary during a flight mission. The generator lubrication system 168 provides lubrication to an electronic generator (not shown), as well as cooling/heat removal for the electronic generator. The electronic generator may provide electrical power to, for example, a startup electrical motor for the engine 100 and/or various other electronic components of the engine 100 and/or an aircraft including the engine 100. The lubrication systems for the engine 100 (e.g., the main lubrication system 162 and the generator lubrication system 168) may use hydrocarbon fluids, such as oil, for lubrication, in which the oil circulates through inner surfaces of oil scavenge lines.

The engine 100 discussed herein is provided by way of example only. In other embodiments, any other suitable engine may be utilized with aspects of the present disclosure. For example, in other embodiments, the engine may be any other suitable gas turbine engine, such as a turboshaft engine, a turboprop engine, a turbojet engine, an unducted single fan engine, and the like. In such a manner, in other embodiments, the gas turbine engine may have other suitable configurations, such as, direct drive configurations, fixed pitch fans, or other suitable numbers or arrangements of shafts, compressors, turbines, fans, etc. Further, although a particular engine 100 is depicted in FIG. 3, the catalyst may be used more generally and/or with other engine embodiments. For example, in alternative embodiments, aspects of the present disclosure may be incorporated into, or otherwise utilized with any other type of engine, such as reciprocating engines. Additionally, in still other exemplary embodiments, the exemplary engine 100 may include or be operably connected to any other suitable accessory systems. Additionally, or alternatively, the exemplary engine 100 may not include or be operably connected to one or more of the accessory systems 162, 164, 166, and 168, discussed above.

FIG. 4 shows a combustor 300 of the combustion section 114 (FIG. 3) according to an embodiment of the present disclosure. FIG. 4 is a detail view showing detail 4 in FIG. 3. The combustor 300 is an annular combustor that includes a combustion chamber 302 defined between an inner liner 304 and an outer liner 306. Each of the inner liner 304 and outer liner 306 is annular about the longitudinal centerline axis 101 of the engine 100 (FIG. 3). The combustor 300 also includes a combustor case 308 that is also annular about the longitudinal centerline axis 101 of the engine 100. The combustor case 308 extends circumferentially around the inner liner 304 and the outer liner 306, and the inner liner 304 and outer liner 306 are located radially inward of the combustor case 308. The combustor 300 also includes a dome 310 mounted to a forward end of each of the inner liner 304 and the outer liner 306. The dome 310 defines an upstream (or forward end) of the combustion chamber 302.

A plurality of mixer assemblies 210 (only one is illustrated in FIG. 4) are spaced around the dome 310. The plurality of mixer assemblies 210 are circumferentially spaced about the longitudinal centerline axis 101 of the engine 100. In the embodiment shown in FIG. 4, each mixer assembly 210 is a twin annular premixing swirler (TAPS) that includes a main mixer 212 and a pilot mixer 214. The pilot mixer is supplied with fuel from the fuel injector 200 during the entire engine operating cycle, and the main mixer 212 is supplied with fuel from the fuel injector 200 only during increased power conditions of the engine operating cycle, such as take-off and climb, for example. The TAPS mixer assembly 210 is provided by way of example and a catalytic metal layer discussed herein may be applied to other mixer assembly designs and other combustor designs.

As noted above, the compressor section 103, including the HP compressor 112 (FIG. 3), pressurizes air, and the combustor 300 receives an annular stream of this pressurized air from a discharge outlet (compressor discharge outlet 216) of the HP compressor 112. This compressed air 141 may also be referred to as compressor discharge pressure air. A portion of the compressor discharge pressure air flows into the mixer assembly 210. Fuel is injected into the compressor discharge pressure air in the mixer assembly 210 to mix with the compressor discharge pressure air and to form a fuel-air mixture. The fuel-air mixture is provided to the combustion chamber 302 from the mixer assembly 210 for combustion. Ignition of the fuel-air mixture is accomplished by a suitable igniter 312, and the resulting combustion gases flow in an axial direction toward and into an annular, first stage turbine nozzle 314. The first stage turbine nozzle 314 is defined by an annular flow channel that includes a plurality of radially extending, circularly-spaced nozzle vanes 316 that turn the gases so that they flow angularly and impinge upon the first stage turbine blades (not shown) of a first turbine (not shown) of the HP turbine 116 (FIG. 3).

The fuel injector 200 is fixed to the combustor case 308 by a nozzle mount. In this embodiment, the nozzle mount is a flange 202 that is integrally formed with a stem 204 of the fuel injector 200. The flange 202 is fixed to the combustor case 308 and sealed to the combustor case 308. The stem 204 includes a flow passage through which the hydrocarbon fuel flows, and the stem 204 extends radially inward from the flange 202. The fuel injector 200 also includes a fuel nozzle tip 220 through which fuel is injected into the combustion chamber 302 as part of the mixer assembly 210.

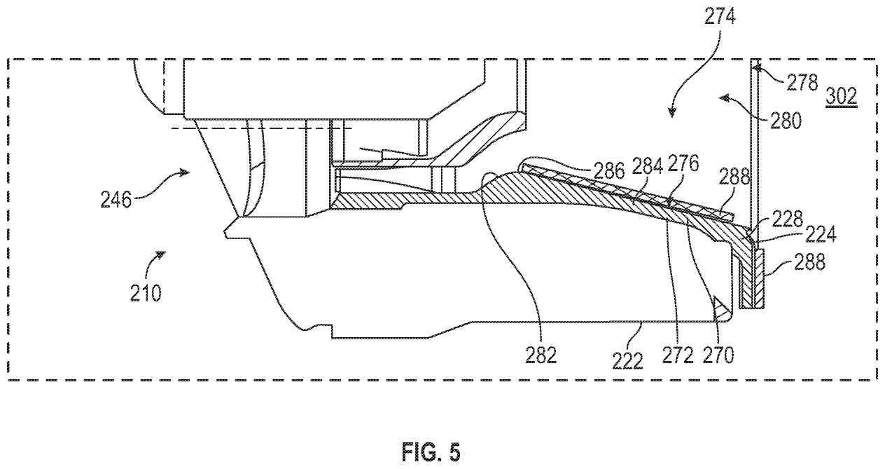

FIG. 5 shows the mixer assembly 210 of the combustor 300 shown in FIG. 4. FIG. 5 is a detail view showing detail 5 in FIG. 4, and, as FIG. 4 is a cross-sectional view, FIG. 5 is also a cross-sectional view of the mixer assembly 210. The fuel nozzle tip 220 (FIG. 4) includes a fuel nozzle body 222 and an aft heat shield 224 attached to the fuel nozzle body 222. The fuel nozzle body 222 may be mounted to, e.g., an inlet fairing. The inlet fairing is connected to or integral with the stem 204 (FIG. 3). The fuel nozzle body 222 may include, for example, a main fuel nozzle and a dual orifice pilot fuel injector tip having a primary pilot fuel orifice and a secondary pilot fuel orifice. The primary pilot fuel orifice and the secondary pilot fuel orifice may be substantially concentric with each other and substantially centered in an annular pilot inlet 246. The main fuel nozzle surrounds the pilot inlet 246, and the pilot inlet 246 is located between the main fuel nozzle and the dual orifice pilot fuel injector tip. In this embodiment, the fuel nozzle tip 220 (see FIG. 4) is circular about an axis extending through the center of the primary pilot fuel orifice. In the discussion below, various features of the fuel nozzle tip 220 may be discussed relative to this axis.

Fuel is provided through the stem 204 to the main fuel nozzle. The main fuel nozzle may include, for example, an annular main fuel passage disposed in an annular main fuel ring. The main fuel nozzle may include, for example, a circular array of main fuel injection orifices or an annular array of main fuel injection orifices extending radially outward from the annular main fuel passage and through the wall of the annular main fuel ring. The main fuel nozzle and the annular main fuel ring are spaced radially outward of the primary pilot fuel orifice and the secondary pilot fuel orifice. The main fuel nozzle injects fuel in a radially outward direction through the circular array of main fuel injection orifices.

Fuel is also provided through the stem 204 to the primary pilot fuel orifice and the secondary pilot fuel orifice. The secondary pilot fuel orifice is radially located directly adjacent to the primary pilot fuel orifice and surrounds the primary pilot fuel orifice. The pilot mixer may include, for example, an inner pilot swirler, an outer pilot swirler, and a swirler splitter positioned between the inner pilot swirler and the outer pilot swirler. The inner pilot swirler is located radially outward of the dual orifice pilot fuel injector tip and adjacent to the dual orifice pilot fuel injector tip. The outer pilot swirler is located radially outward of the inner pilot swirler. The swirler splitter may extend, for example, downstream of the dual orifice pilot fuel injector tip and a first venturi is formed in a downstream portion of the swirler splitter. The first venturi may include, for example, a converging section, a diverging section, and a throat between the converging section and the diverging section. The throat is located downstream of the primary pilot fuel orifice and the secondary pilot fuel orifice. The swirler splitter and, more specifically, the downstream portion of the swirler splitter forms a housing for the first venturi. The inner pilot swirler and the outer pilot swirler are generally oriented parallel to a centerline of the dual orifice pilot fuel injector tip. The inner pilot swirler and the outer pilot swirler may include, for example, a plurality of swirling vanes for causing air traveling therethrough to swirl.

A portion of the compressor discharge pressure air flows into the mixer assembly pilot inlet 246 and, then, into the inner pilot swirler and the outer pilot swirler. As noted above, fuel and air are provided to the pilot mixer at all times during the engine operating cycle so that a primary combustion zone is produced within a central portion of the combustion chamber 302. The primary pilot fuel orifice is circular, and the secondary pilot fuel orifice is annular. Each of the primary pilot fuel orifice and the secondary pilot fuel orifice injects fuel in a generally downstream direction and into the compressed air 141 (FIG. 3) flowing through the inner pilot swirler. The primary pilot fuel orifice and the secondary pilot fuel orifice are examples of a fuel injection port that is fluidly connected to a fuel source and configured to inject a hydrocarbon fuel into the mixer assembly. This fuel and air mixture flows through the first venturi and exits through, for example, a circular outlet. The outlet is downstream of the diverging section.

The pilot mixer is supported by an annular pilot housing 270. The pilot housing 270 includes a conical wall section 272 circumscribing a conical pilot mixing chamber 274 that is in flow communication with, and downstream from, the pilot mixer, and, more specifically, the outlet. The pilot mixing chamber 274 is also fluidly connected to the primary pilot fuel orifice and the secondary pilot fuel orifice, and downstream of the primary pilot fuel orifice and the secondary pilot fuel orifice. The pilot mixing chamber 274 is a passage of the fuel injector 200 (FIG. 3) and, more specifically, the fuel nozzle tip 220. As the fuel nozzle tip 220 is also a portion of the mixer assembly 210, the pilot mixing chamber 274 also is a passage of the mixer assembly 210.

The conical wall section 272 of the pilot housing 270 is thus a passage wall that includes a passage wall surface 276 facing the pilot mixing chamber 274 (passage). In this embodiment, the conical wall section 272 is part of a second venturi 280 formed by the pilot housing 270. The second venturi 280 includes a converging section 282, a diverging section 284, and a throat 286 between the converging section 282 and the diverging section 284. The diverging section 284 is provided by the conical wall section 272, which extends downstream from the throat 286 and continues with exposed surfaces 228 of the aft heat shield 224. Diverging section 284 has an upstream end, which, in this embodiment, is the throat 286 and a downstream end, which, in this embodiment, is an outlet 278 of the pilot mixing chamber 274. As can be seen in FIG. 5, the cross-sectional area of the second venturi 280 at the outlet 278 (the downstream end) is greater than the cross-sectional area of the second venturi 280 at the throat 286 (the upstream end).

Air flows through the outer pilot swirler through the converging section 282 toward the throat 286. This air is mixed with the fuel-air mixture from the outlet and moves through the throat 286 to the diverging section 284 and the aft heat shield 224. The pilot mixing chamber 274 and, more specifically, the wall surface 276 of the conical wall section 272 are exposed to hydrocarbon fuel as the fuel-air mixture flows through the pilot mixing chamber 274, through the outlet 278 of the pilot mixing chamber 274, and into the combustion chamber 302. Being adjacent to the combustion chamber 302 and adjacent to the primary combustion zone, the fuel, the conical wall section 272, and the aft heat shield 224 are exposed to high temperatures. For example, the conical wall section 272 and the aft heat shield 224 may be at temperatures from five hundred and seventy degrees Fahrenheit (three hundred degrees Celsius) to one thousand one hundred degrees Fahrenheit (five hundred ninety three degrees Celsius) and from one thousand one hundred degrees Fahrenheit (five hundred ninety three degrees Celsius) to two thousand five hundred degrees Fahrenheit (one thousand three hundred seventy one degrees Celsius), respectively.

The pilot housing 270 and the aft heat shield 224 are made from materials suitable for use in these high temperature environments including, for example, stainless steel, corrosion-resistant alloys of nickel and chromium, and high-strength nickel-base alloys. The pilot housing 270 and the aft heat shield 224 may thus be formed from a metal alloy chosen from the group consisting of iron-based alloys, nickel-based alloys, cobalt-based alloys, and chromium-based alloys. Exposed surfaces of these materials at these temperatures, and, more particularly, the wall surface 276 may thus be susceptible to a significant build-up of coke and/or partially burned fuel deposits. The coke forming on such materials may be strongly bound to the surfaces of the fuel nozzle components leading to the formation of a thick layer of coke with large particles. As noted above, coke can build up in considerable thickness on these surfaces and large pieces of coke can shed off, becoming internal domestic objects that can cause significant damage to components downstream of the fuel nozzle (hot gas path components).

To prevent the build-up of coke and the issues discussed above, at least a portion of the surfaces of the second venturi 280, including, for example, the wall surface 276 and the aft heat shield 224 may be coated with the catalyst (referred to herein as a catalyst coating 288) to inhibit coke deposition and build-up. The composition of the catalyst coating 288 may be the same on each of the wall surface 276 and the aft heat shield 224, but alternatively, the wall surface 276 and the aft heat shield 224 may have a composition independently chosen from any of the catalyst compositions disclosed herein. As noted above, the pilot mixing chamber 274 is a passage, and, in embodiments discussed herein, a portion of the wall of the passage is a coated passage wall that is coated with the catalyst (the catalyst coating 288). The coated passage wall is located downstream of the fuel injection port (the primary pilot fuel orifice and the secondary pilot fuel orifice, in this embodiment). As noted above, air flows through the pilot mixing chamber 274 (passage) and is introduced by an air inlet. In these embodiments, the air inlet is upstream of the coated passage wall. More specifically, air is introduced into the pilot mixing chamber 274 (passage) by the pilot inlet 246, through the inner pilot swirler and the outer pilot swirler. The air flowing through the inner pilot swirler is also introduced to the pilot mixing chamber 274 via outlet.

Exposed surfaces of the underlying (base) material of the pilot housing 270, and, more specifically, the conical wall section 272 or the aft heat shield 224, promote the formation of thick, large chunks of coke, and the catalyst coating 288 of this embodiment is applied as a continuous layer on the wall surface 276 to avoid discontinuities that would expose the base material. Only a thin layer of the catalyst is needed to mitigate the formation and liberation of large coke chunks. Depending on the application region, the thickness of the catalyst coating 288 can be suitably determined to account for, for example, the coke buildup rate, catalyst wear rate, etc. For example, in some embodiments, higher thicknesses can help if the layer is being continuously eroded/corroded during operation. On the other hand, in some embodiments, thicker layers may lead to more instability issues with respect to coating delamination/spallation because of cycling thermal stresses. As such, in some embodiments, the thickness is controlled to prevent spalling and improve coating durability and as well as account for loss by erosion/corrosion. The catalyst coating 288 may have a thickness of, for example, less than two hundred microns, such as less than one hundred microns. In some embodiments, the thickness of the catalyst coating 288 may be from ten microns to two hundred microns (e.g., from ten microns to one hundred microns). In other embodiments, the catalyst coating 288 may have a thickness of, for example, less than three hundred nanometers such as less than one hundred nanometers. In some embodiments, the thickness of the catalyst coating 288 may be from twenty nanometers to three hundred nanometers. In some embodiments, the thickness of the catalyst coating 288 may be from three hundred nanometers to ten microns. The catalyst may include particles having a size of, for example, less than or equal to five microns, less than or equal to one hundred nanometers, or less than or equal to fifty nanometers. In some embodiments, the size of the catalyst particles may be less than or equal to twenty-five nanometers. In some embodiments, the size of the catalyst particles may be from one hundred nanometers to ten microns, from 0.5 microns to one micron, or from twenty-five nanometers to two hundred nanometers.

In some embodiments, the catalyst coating can have a porosity ranging from forty percent to seventy percent, which may enhance catalyst efficiency owing to an increased surface area. In some embodiments, the porosity can range from ten percent to thirty percent.

The catalyst coating 288 may have a smooth surface finish having a surface roughness Ra ranging from 0.01 microns to 0.4 microns. A smooth surface finish may also help to prevent coke from sticking to the second venturi 280. In some embodiments, the catalyst coating 288 may have a surface finish having a surface roughness Ra from five microns to ten microns when deposited using, for example, an air plasma spray and, in other embodiments, from 0.5 microns to 1.5 microns when deposited using, for example, electron beam physical vapor deposition. Other techniques of catalyst coating deposition may include slurry spray, suspension plasma spray, and solution precursor plasma spray, all of which may have a surface finish having a surface roughness Ra ranging from 0.5 microns to ten microns.

The catalyst coating 288 may be applied using any suitable method such as those methods that produce a continuous or a sporadic catalyst particle layer with the thicknesses, the sizes, and the surface finishes discussed above. The components discussed herein, such as the diverging section 284 of the second venturi 280 and the exposed surfaces 228 of the aft heat shield 224 can be coated using, for example, liquid spray followed by thermal consolidation (using gel-forming precursor solutions, non-gel-forming precursor solutions, or slurry suspensions), suspension-based or precursor solution-based plasma spray, air plasma spray, electron beam physical vapor deposition, screen-printing, electrodeposition, etching, lithography, or sputtering. For example, a catalyst coating can exist as a homogenous composite and can be homogenously coated to the surface of interest by wet chemical methods.

In some embodiments, coatings applied to aircraft engine components may benefit from repair or re-building to sustain and/or enhance their performance and durability. Such repair or rebuilding can be performed “on-wing,” for example, that is, without engine disassembly or removal of target components. The wet chemical formulations for catalytic coating applications described above (such as the sol-forming and non-sol-forming solutions, suspensions, and slurries) are suited for such on-wing repair or rebuilding using robotic techniques, accessed, for example, through boroscope ports. The formulation can be directly coated onto the target surfaces and/or repair locations by spraying through nozzles, guided by, for example, a boroscope imaging camera.

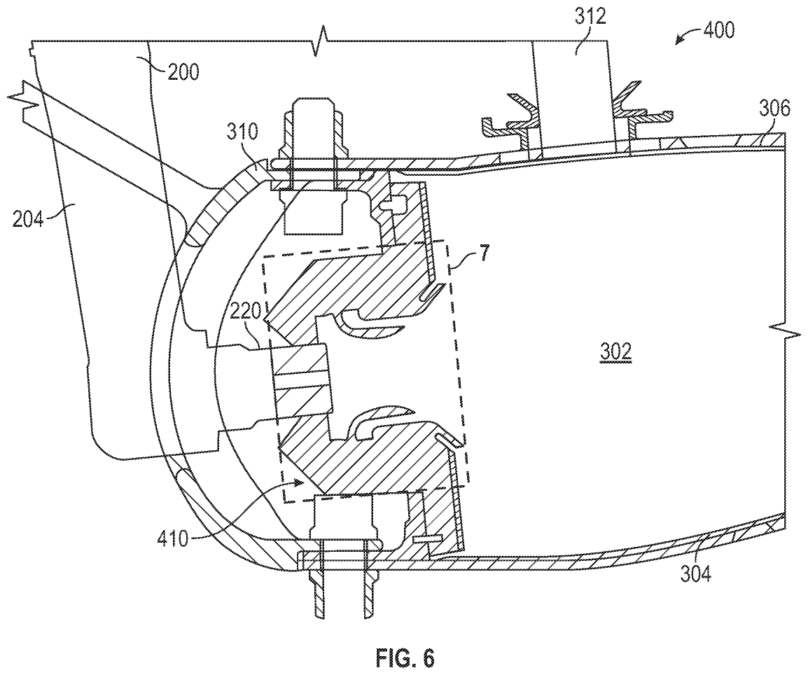

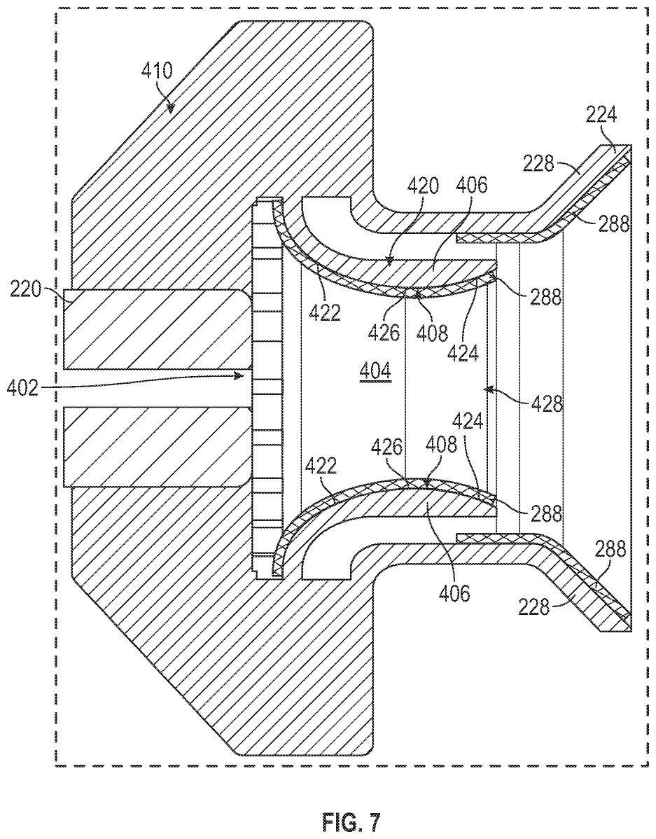

In the preceding discussion, the combustor 300 (FIG. 4) and the mixer assembly 210 (FIG. 5) were configured to use a twin annular premixing swirler (TAPS), but the catalyst coating 288 discussed herein may be applied to other mixer assembly designs and other combustor designs. Another example of a combustor 400 is shown in FIG. 6. FIG. 6 is a cross-sectional view of the combustor 400 showing a rich burn combustor design. FIG. 7 shows a mixer assembly 410 of the combustor 400 shown in FIG. 6. FIG. 7 is a detail view showing detail 7 in FIG. 6, and, as FIG. 6 is a cross-sectional view, FIG. 7 is also a cross-sectional view of the mixer assembly 410. The combustor 400 and the mixer assembly 410 of this embodiment include the same or similar components as the combustor 300 and the mixer assembly 210 discussed above. Components in this embodiment that are the same or similar to those discussed above are identified with the same reference numeral and a detailed description of these components is omitted.

The combustor 400 of this embodiment shows a rich burn combustor. A plurality of mixer assemblies 410 (only one is illustrated) are spaced around the dome 310. Fuel is injected into the mixer assembly 410 by a fuel injection port 402. The fuel injection port 402 injects fuel in a generally downstream direction and into the compressed air flowing through a first swirler (not shown). The fuel is injected into a mixing chamber 404 that mixes the fuel with the compressed air to form a fuel-air mixture. As with the pilot mixing chamber 274 (FIG. 5) discussed above, the mixing chamber 404 of this embodiment is a passage of the fuel injector 200 with a wall section 406 that includes a passage wall surface 408 facing the mixing chamber 404 (passage). In this embodiment, wall section 406 is part of a venturi 420 that includes a converging section 422, a diverging section 424, and a throat 426 between the converging section 422 and the diverging section 424. In this embodiment, the catalyst coating 288 is formed on the surfaces of the venturi 420. The fuel-air mixture exits through an outlet 428 of the mixing chamber 404 and is combined with air flowing through a second swirler (not shown) at a position upstream of the exposed surfaces 228 of the aft heat shield 224. In this embodiment, the catalyst coating 288 is also formed on the exposed surface 228 of the aft heat shield 224.

As discussed above, the aft heat shield 224 can be exposed to a low-oxygen environment during engine operation, and coke deposits (e.g., carbon-based deposits) may form on the aft heat shield 224. As such, it can be beneficial to coat the aft heat shield 224 with the catalyst coating 288 at least because the catalyst coating 288 can reduce or eliminate the formation of coke deposits on the aft heat shield 224 by oxidizing the coke under the low-oxygen conditions present at the aft heat shield 224 during engine operation.

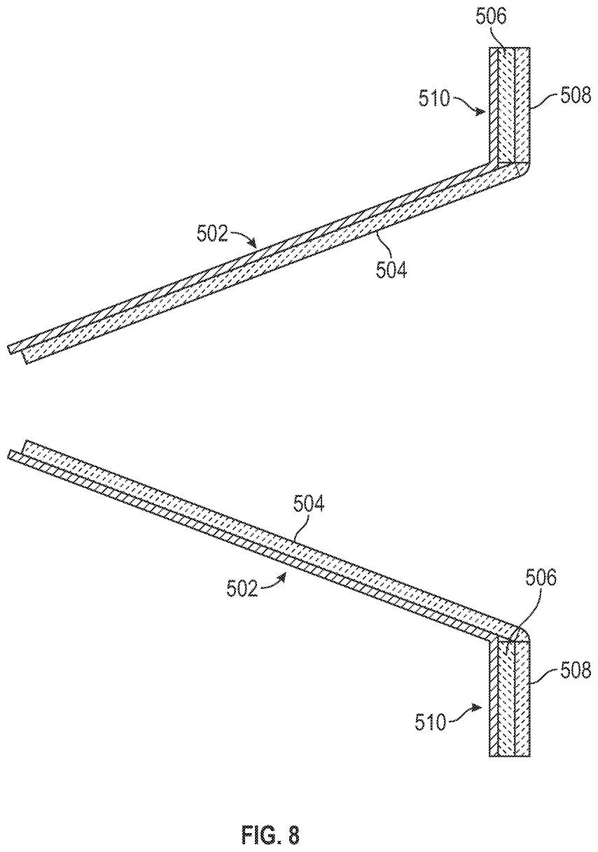

More generally, FIG. 8 depicts a catalyst coating 504 on substrate which, in FIG. 8, is a surface of a venturi wall 502. Additionally, or alternatively, a catalyst coating 508 can exist on other substrates such as the surface of the TBC 506, which exists on the surface of the AHS 510. The description of such components above applies here.

### EXAMPLES

Specific embodiments will be demonstrated by reference to the following examples. These examples are disclosed solely by way of illustrating the present disclosure and should not be taken in any way to limit the scope of the present disclosure.

### Example 1

Catalyst 1a was about 20 mol % SiO₂, 39 mol % CeO₂, 1 mol % Gd₂O₃, 15 mol % CaO, 5 mol % MgO, 5 mol % Al₂O₃, rest miscellaneous metal oxides.

Catalyst 1b is about 20 mol % SiO₂, 40 mol % CeO₂, 15 mol % CaO, 5 mol % MgO, 5 mol % Al₂O₃, rest miscellaneous metal oxides.

Catalyst 2a was of formula Gd_{0.1}Ce_{0.9}O_{2-y} where y was not determined but was expected to range from 0.02 to 0.2.

Catalyst 2b was of formula CeO_{2-y} where y was not determined but was expected to range from 0.02 to 0.2.

For both catalyst types, the powder mixtures were first heat-treated at two thousand to two thousand five hundred and fifty degrees Fahrenheit (one thousand ninety three to one thousand four hundred degrees Celsius) for two to six hours.

Heat-treated samples were crushed into powder and stored in a desiccator.

The catalytic activity of the catalysts towards carbon oxidation was assessed by thermal analyzer (STA/Netzsch-STA 449 Jupiter, Germany) under low oxygen partial pressures. The catalyst powders were mixed with carbon black (4:1 weight ratio) and pressed into small pellets. For each run, around 50 mg of pellet was used in an alumina crucible. Heat flux and mass loss were continuously monitored as temperature was ramped to two thousand three hundred seventy degrees Fahrenheit (one thousand three hundred degrees Celsius) at fifty degrees Fahrenheit (ten degrees Celsius) per minute. The low oxygen partial pressure (pO₂ 0.02 atmospheres) used in the run was achieved by mixing controlled flowrates of air and UHP Ar gas into the sample chamber.

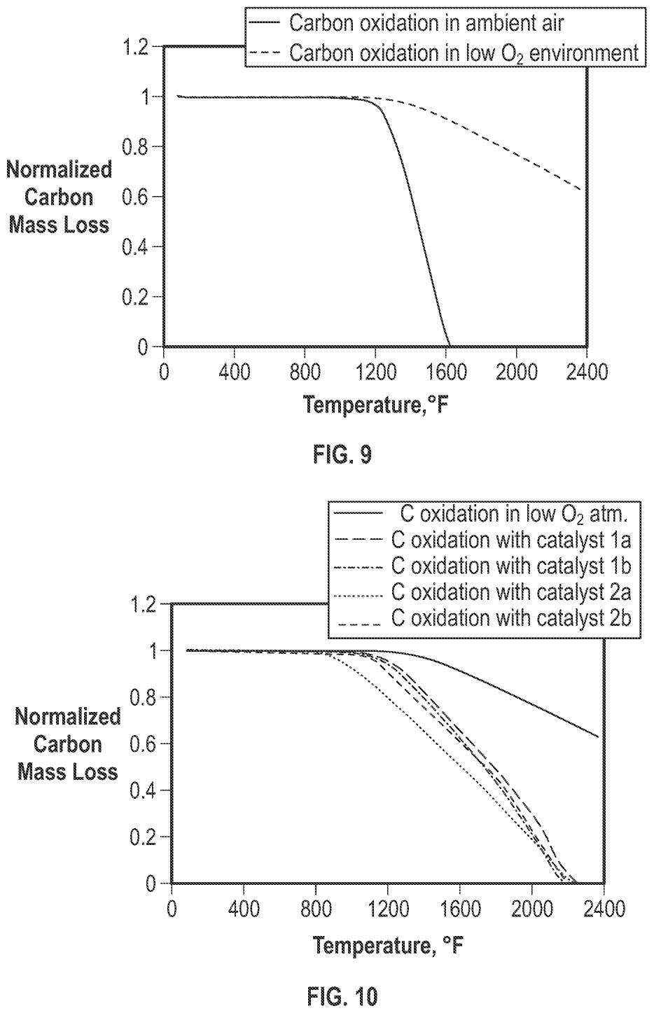

Carbon oxidation (or carbon mass loss) under low oxygen partial pressure environments with various catalyst powders was plotted using a normalized mass loss plot with respect to temperature. FIG. 9 depicts normalized carbon mass loss with temperature for a control sample that does not include the catalyst in both ambient and low oxygen partial pressure environments. FIG. 10 depicts normalized carbon mass loss with temperature for the catalyst samples in low oxygen partial pressure environments. Comparing the results of FIG. 10 with that of FIG. 9, which shows normalized mass loss plot for a control sample that does not have any catalyst, one observes that the catalysts improve coke oxidation in the low oxygen environment. The inventors surprisingly found that the catalysts are effective for oxidizing coke at an oxygen partial pressure of 0.02 atmospheres with an oxidation onset temperature ranging from eight hundred degrees Fahrenheit (four hundred twenty seven degrees Celsius) to one thousand two hundred degrees Fahrenheit (six hundred fifty degrees Celsius), as depicted in FIG. 10.

Further aspects of the present disclosure are provided by the subject matter of the following clauses.

A catalyst for oxidizing coke in a low oxygen environment. The catalyst includes a compound of formula NₓM₁₋ₓO_{2-y}. In the formula, x ranges from 0 to 0.9, y ranges from 0.02 to 0.9, N includes at least one of an alkaline-earth cation, an aluminum cation, a transition metal cation, or a rare-earth cation, M is silicon or a rare-earth element, and N has a different atomic radius than M, N has a different oxidation state than M, or N has a different atomic radius and a different oxidation state than M.

The catalyst of the preceding clause, such that x ranges from 0.2 to 0.9, M is silicon, N is at least two of alkaline-earth cations, aluminum cation, transition metal cations, or rare-earth cations.

The catalyst of any preceding clause, such that at least fifty weight percent of the catalyst includes the silicon dioxide and the at least two cations.

The catalyst of any preceding clause, such that at least ninety-five weight percent of the catalyst includes the silicon dioxide and the at least two cations.

The catalyst of any preceding clause, such that the catalyst has from zero mole percent to fifty mole percent alkaline-earth cations.

The catalyst of any preceding clause, such that the catalyst has from zero mole percent to twenty mole percent aluminum cations.

The catalyst of any preceding clause, such that the catalyst has from zero mole percent to twenty mole percent transition metal cations.

The catalyst of any preceding clause, such that the catalyst has from zero mole percent to eighty mole percent rare-earth cations.

The catalyst of any preceding clause, such that the catalyst has a ratio of silicon to alkaline-earth cations ranging from one to ten.

The catalyst of any preceding clause, such that the catalyst has a ratio of silicon to aluminum cations ranging from one to twenty.

The catalyst of any preceding clause, such that the catalyst has a ratio of Si to transition metal cations ranging from one to twenty.

The catalyst of any preceding clause, such that the catalyst has a ratio of Si to rare-earth cations ranging from 0.5 to four.

The catalyst of any preceding clause, such that the catalyst has from thirty mole

percent to forty mole percent alkaline-earth cations.

The catalyst of any preceding clause, such that the catalyst has from five mole percent to ten mole percent aluminum cations.

The catalyst of any preceding clause, such that the catalyst has from five mole percent to ten mole percent transition metal cations.

The catalyst of any preceding clause, such that the catalyst has from thirty mole percent to sixty mole percent rare-earth cations.

The catalyst of any preceding clause, such that the catalyst has a ratio of silicon to alkaline-earth cations ranging from five to ten.

The catalyst of any preceding clause, such that the catalyst has a ratio of silicon to aluminum cations ranging from ten to fifteen.

The catalyst of any preceding clause, such that the catalyst has a ratio of silicon to transition metal cations ranging from ten to fifteen.

The catalyst of any preceding clause, such that the catalyst has a ratio of silicon to rare-earth cations ranging from one to two.

The catalyst of any preceding clause, such that x is zero, y ranges from 0.02 to 0.1, and M is a rare-earth element.

The catalyst of any preceding clause, such that M is cerium.

The catalyst of any preceding clause, such that x ranges from 0.02 to 0.5, y ranges from 0.02 to 0.1, and M is a rare-earth element, and N includes a rare-earth cation.

The catalyst of any preceding clause, such that M is cerium.

The catalyst of any preceding clause, such that N includes gadolinium.

The catalyst of the preceding clause, such that N further includes lanthanum.

The catalyst of any preceding clause, such that the catalyst is effective for oxidizing coke at an oxygen partial pressure of 0.02 atmospheres with an oxidation onset temperature ranging from eight hundred degrees Fahrenheit (four hundred twenty seven degrees Celsius) to one thousand six hundred degrees Fahrenheit (eight hundred seventy one degrees Celsius).

The catalyst of any preceding clause, such that the catalyst is free from platinum group metals.

The catalyst of any preceding clause, such that the catalyst is free from noble metals.

The catalyst of any preceding clause, such that the catalyst has one or more of from 0 mole percent to 50 mole percent alkaline alkaline-earth cations, from 0 mole percent to 20 mole percent aluminum cations, from 0 mole percent to 20 mole percent transition metal cations, or from 0 mole percent to 80 mole percent rare-earth cations, and wherein the catalyst has one or more of a ratio of silicon to alkaline-earth cations ranging from 1 to 10, a ratio of silicon to aluminum cations ranging from 1 to 20, a ratio of silicon to transition metal cations ranging from 1 to 20, or a ratio of silicon to rare-earth cations ranging from 0.5 to 4.

The catalyst of any preceding clause, such that the catalyst has one or more of from 30 mole percent to 40 mole percent alkaline alkaline-earth cations, from 5 mole percent to 10 mole percent aluminum cations, from 5 mole percent to 10 mole percent transition metal cations, or from 30 mole percent to 60 mole percent rare-earth cations, and wherein the catalyst has one or more of a ratio of silicon to alkaline-earth cations ranging from 5 to 10, a ratio of silicon to aluminum cations ranging from 10 to 15, a ratio of silicon to transition metal cations ranging from 10 to 15, or a ratio of silicon to rare-earth cations ranging from 1 to 2.

The catalyst of any preceding clause, such that the catalyst consists of the compound of formula NₓM₁₋ₓO_{2-y}.

The catalyst of any preceding clause, such that the catalyst consists essentially of the compound of formula NₓM₁₋ₓO_{2-y}.

The catalyst of any preceding clause, such that N consists of at least one of an alkaline-earth cation, an aluminum cation, a transition metal cation, or a rare-earth cation, and the N, the M, the x, and the y are chosen such that the catalyst is effective for oxidizing coke at an oxygen partial pressure of 0.02 atmospheres with an oxidation onset temperature ranging from eight hundred degrees Fahrenheit (four hundred twenty seven degrees Celsius) to one thousand six hundred degrees Fahrenheit (eight hundred seventy one degrees Celsius).

The catalyst of any preceding clause, such that N consists of at least one of an alkaline-earth cation, an aluminum cation, a transition metal cation, or a rare-earth cation, and the N, the M, the x, and the y are chosen such that the catalyst is effective for oxidizing coke at an oxygen partial pressure of 0.02 atmospheres with an oxidation onset temperature ranging from eight hundred degrees Fahrenheit (four hundred twenty seven degrees Celsius) to one thousand two hundred degrees Fahrenheit (six hundred fifty degrees Celsius).

The catalyst of any preceding clause, such that N consists of at least one of an alkaline-earth cation, an aluminum cation, a transition metal cation, or a rare-earth cation, and the N, the M, the x, and the y are chosen such that the catalyst is effective for oxidizing coke at an oxygen partial pressure of 0.02 atmospheres with an oxidation onset temperature ranging from eight hundred degrees Fahrenheit (four hundred twenty seven degrees Celsius) to one thousand degrees Fahrenheit (five hundred thirty eight degrees Celsius).

A coated substrate including the catalyst of any preceding clause coated on a substrate chosen from a metal substrate and a ceramic substrate.

The coated substrate of the preceding clause, such that the ceramic substrate comprises a layer of ceramic coated on a metal.

The coated substrate of any preceding clause, such that the layer of ceramic is a thermal barrier coating and the metal is chosen from iron-based alloys, nickel-based alloys, cobalt-based alloys, alloys containing cobalt and chromium, alloys containing platinum and aluminum, alloys containing nickel and aluminum, and alloys containing nickel, chromium, aluminum and yttrium.

The coated substrate of any preceding clause, such that the thermal barrier coating comprises (ZrO₂)_{(1-z)}(Y₂O₃)_{z}, wherein z ranges from 0.04 to 0.5.

The coated substrate of any preceding clause, such that the metal substrate is chosen from iron-based alloys, nickel-based alloys, cobalt-based alloys, alloys containing cobalt and chromium, alloys containing platinum and aluminum, alloys containing nickel and aluminum, and alloys containing nickel, chromium, aluminum, and yttrium.

The coated substrate of any preceding clause, such that the coated substrate is an aircraft component.

The coated substrate of any preceding clause, such that the coated substrate is a gas turbine engine component.

The coated substrate of any preceding clause, such that the aircraft component is chosen from a fuel circuit component, a lube oil circuit component, a fuel nozzle, a mixer assembly component, and an aft heat shield.

The coated substrate of any preceding clause, such that the aircraft component is downstream of a combustion chamber.

A method of oxidizing coke in a low oxygen environment, the method including contacting the catalyst of any preceding clause with coke in the low oxygen environment, wherein the low oxygen environment has a partial pressure of oxygen ranging from 0.5 percent to twenty percent by volume, at a temperature ranging from one thousand degrees Fahrenheit (five hundred thirty eight degrees Celsius) to three thousand degrees Fahrenheit (one thousand six hundred fifty degrees Celsius).

A method of oxidizing coke in a low oxygen environment, the method including contacting the coated substrate of any preceding clause with coke in the low oxygen environment, wherein the low oxygen environment has a partial pressure of oxygen ranging from 0.5 percent to twenty percent by volume, at a temperature ranging from one thousand degrees Fahrenheit (five hundred thirty-eight degrees Celsius) to three thousand degrees Fahrenheit (one thousand six hundred fifty degrees Celsius).

A mixer assembly for a gas turbine engine includes a housing having a passage formed therein and a passage wall facing the passage, and a fuel injection port fluidly connected to a fuel source and configured to inject a hydrocarbon fuel into the passage. At least a portion of the passage wall is a coated passage wall, the coated passage wall being (i) coated with a catalyst of any of the preceding clauses and (ii) located downstream of the fuel injection port.

The mixer assembly of the preceding clause, such that the catalyst has particles having a size of less than or equal to five microns, optionally, ranging from 0.5 microns to one micron, or optionally ranging from twenty-five nanometers to two hundred nanometers.

The mixer assembly of any preceding clause, an operating temperature ranging from three hundred degrees Fahrenheit (one hundred fifty degrees Celsius) to one thousand one hundred degrees Fahrenheit (five hundred ninety three degrees Celsius) or an operating temperature ranging from one thousand one hundred degrees Fahrenheit (five hundred ninety three degrees Celsius) to two thousand five hundred and fifty degrees Fahrenheit (one thousand four hundred degrees Celsius).

The mixer assembly of any preceding clause, the passage being a venturi including a diverging section, the passage wall including the diverging section, or the coated passage wall including the diverging section.

The mixer assembly of any preceding clause, the passage including an aft heat shield, the coated passage wall including a surface of the aft heat shield.

The mixer assembly of any preceding clause, the aft heat shield including a thermal barrier coating, the layer of the plurality of the catalyst particle being coated onto a surface of the thermal barrier coating.

The mixer assembly of any preceding clause, including a pilot fuel injector tip including a least one pilot fuel orifice, the fuel injection port being the pilot fuel orifice, and a pilot swirler located radially outward of the pilot fuel injector tip and adjacent to the pilot fuel injector tip, air being configured to flow through the pilot swirler and to mix with fuel from the pilot fuel orifice as a fuel-air mixture, the pilot swirler having an outlet configured to discharge the fuel-air mixture into the passage.

The mixer assembly of any preceding clause, including an array of main fuel injection orifices configured to inject fuel in a radially outward direction, the main fuel injection orifices being located radially outward from the passage.

The mixer assembly of any preceding clause, the passage being a venturi including a converging section, a diverging section, and a throat, the coated passage wall including a passage wall of the diverging section, and the outlet of the pilot swirler being located upstream of the diverging section.

A method of repairing or re-building a mixer assembly of any preceding clause, comprising coating at least a portion of the passage wall with the catalyst of any of the preceding clauses, such that the coated passage wall is located downstream of a fuel injection port.

A gas turbine engine includes a combustor including a combustion chamber, and the mixer assembly of any preceding clause configured to inject a mixture of air and hydrocarbon fuel into the combustion chamber.

Although the foregoing description is directed to some exemplary embodiments of the present disclosure, other variations and modifications will be apparent to those skilled in the art, and may be made without departing from the disclosure. Moreover, features described in connection with one embodiment of the present disclosure may be used in conjunction with other embodiments, even if not explicitly stated above.

1. A catalyst for oxidizing coke in a low oxygen environment, the catalyst comprising:
a compound of formula NₓM₁₋ₓO_{2-y},
wherein:
x ranges from 0 to 0.9;
y ranges from 0.02 to 0.2;
N comprises at least one of an alkaline-earth cation, an aluminum cation, a transition metal cation, or a rare-earth cation;
M is silicon or a rare-earth element; and
N has a different atomic radius than M, N has a different oxidation state than M, or N has a different atomic radius and a different oxidation state than M.

2. The catalyst of claim 1, wherein:
N consists of the at least one of an alkaline-earth cation, an aluminum cation, a transition metal cation, or a rare-earth cation; and
the N, the M, the x, and the y are chosen such that the catalyst is effective for oxidizing coke at an oxygen partial pressure of 0.02 atmospheres with an oxidation onset temperature ranging from eight hundred degrees Fahrenheit to one thousand six hundred degrees Fahrenheit.

3. The catalyst of claim 1, wherein x ranges from 0.2 to 0.9, M is silicon, N is at least two of alkaline-earth cations, aluminum cation, transition metal cations, or rare-earth cations.

4. The catalyst of claim 3, wherein silicon dioxide and the at least two cations account for at least fifty weight percent of the catalyst.

5. The catalyst of claim 3, wherein the catalyst has one or more of:
from 0 mole percent to 50 mole percent alkaline-earth cations;
from 0 mole percent to 20 mole percent aluminum cations;
from 0 mole percent to 20 mole percent transition metal cations; or
from 0 mole percent to 80 mole percent rare-earth cations, and wherein the catalyst has one or more of:
a ratio of silicon to alkaline-earth cations ranging from 1 to 10;
a ratio of silicon to aluminum cations ranging from 1 to 20;
a ratio of silicon to transition metal cations ranging from 1 to 20; or
a ratio of silicon to rare-earth cations ranging from 0.5 to 4.

6. The catalyst of claim 3, wherein the catalyst has one or more of:
from 30 mole percent to 40 mole percent alkaline-earth cations;
from 5 mole percent to 10 mole percent aluminum cations;
from 5 mole percent to 10 mole percent transition metal cations; or
from 30 mole percent to 60 mole percent rare-earth cations, and wherein the catalyst has one or more of:
a ratio of silicon to alkaline-earth cations ranging from 5 to 10;
a ratio of silicon to aluminum cations ranging from 10 to 15;
a ratio of silicon to transition metal cations ranging from 10 to 15; or
a ratio of silicon to rare-earth cations ranging from 1 to 2.

7. The catalyst of claim 1, wherein x is zero, y ranges from 0.02 to 0.1, and M is a rare-earth element.

8. The catalyst of claim 7, wherein M is cerium.

9. The catalyst of claim 1, wherein x ranges from 0.02 to 0.5, y ranges from 0.02 to 0.1, and M is a rare-earth element, and N comprises a rare-earth cation.

10. The catalyst of claim 9, wherein M is cerium.

11. The catalyst of claim 9, wherein N comprises gadolinium.

12. The catalyst of claim 11, wherein N further comprises lanthanum.

13. A coated substrate comprising the catalyst of claim 1 coated on a substrate chosen from a metal substrate and a ceramic substrate.

14. The coated substrate of claim 13, wherein the coated substrate is a gas turbine engine component.

15. The coated substrate of claim 13, wherein the coated substrate is an aircraft component chosen from a fuel circuit component, a lube oil circuit component, a fuel nozzle, a mixer assembly component, and an aft heat shield.

16. The coated substrate of claim 13, wherein the metal substrate is chosen from iron-based alloys, nickel-based alloys, cobalt-based alloys, alloys containing cobalt and chromium, alloys containing platinum and aluminum, alloys containing nickel and aluminum, and alloys containing nickel, chromium, aluminum, and yttrium.

17. The coated substrate of claim 13, wherein the ceramic substrate comprises a layer of ceramic coated on a metal.

18. The coated substrate of claim 17, wherein the layer of ceramic is a thermal barrier coating and the metal is chosen from iron-based alloys, nickel-based alloys, cobalt-based alloys, alloys containing cobalt and chromium, alloys containing platinum and aluminum, alloys containing nickel and aluminum, and alloys containing nickel, chromium, aluminum and yttrium.

19. The coated substrate of claim 18, wherein the thermal barrier coating comprises (ZrO₂)_{(1-z)}(Y₂O₃)_{z}, wherein z ranges from 0.04 to 0.5.

20. A method of oxidizing coke in a low oxygen environment comprising:
contacting the catalyst of claim 1 with coke in the low oxygen environment,
wherein the low oxygen environment has a partial pressure of oxygen ranging from 0.5 percent to 21 percent by volume, at a temperature ranging from 1000° F. to 3000° F.
